(19) United States
(12) Patent Application Publication
(10) Pub. No.: US 2015/0252197 A1
(43) Pub. Date: Sep. 10, 2015

(54) NANO-COMPOSITE POLYMERIC COATING FOR THE CONSERVATION OF LEATHERS AND METHOD FOR SYNTHESIZING THE SAME

(71) Applicant: Iran Polymer and Petrochemical Institute (IPPI), Tehran (IR)

(72) Inventors: Amir Ershad Langroudi, Tehran (IR); Akram Mirmontahaiy, Tehran (IR)

(73) Assignee: Iran Polymer and Petrochemical Institute (IPPI), Tehran (IR)

(21) Appl. No.: 14/611,911

(22) Filed: Feb. 2, 2015

Related U.S. Application Data
(60) Provisional application No. 61/936,871, filed on Feb. 6, 2014.

(51) Int. Cl. C09D 1/00; C14C 99/00; C14C 11/00; C08K 5/06; C08K 3/32

(52) U.S. Cl. CPC C09D 1/00; C08K 5/06; C08K 3/32; C14C 11/003; C14C 99/00; C08K 2003/325

(57) ABSTRACT

The synthesis of a nano-composite, composed of hydroxyapatite (HA) nanoparticles dispersed in polyethylene glycol (PEG) applicable for long-term preservation of historical leather and parchment samples. The nano-composite is synthesized through a simple method by a two phase mixing process at ambient temperature. The mechanical behavior analysis of goat historical leather treated with the prepared nano-composite revealed more softness, better mechanical properties and less structural changes in comparison with the untreated sample. Furthermore, thermal analysis results have confirmed that nano-composite treatment causes a softer amorphous structure with higher water content, more structural homogeneity, and the temperature that maximum weight losing occurred is higher than those for the untreated sample.

### CROSS REFERENCE TO RELATED APPLICATION

The present invention claims priority from pending U.S. Provisional Patent Application Ser. No. 61/936,871, filed Feb. 6, 2014, entitled “Conservation of Ancient Leather by Nano-composite Polymeric Coating Based on PEG and Suspended Hydroxyapatite Nanoparticles”, the subject matter of which is incorporated by reference herein in its entirety.

### SPONSORSHIP STATEMENT

This application has been sponsored by the Iranian Nanotechnology Initiative Council, which does not have any rights in this application.

### TECHNICAL FIELD

The present invention relates to a nano-composite polymeric compound based on polyethylene glycol (PEG) and suspended hydroxyapatite (HA), a method for preparing the same, and the use thereof for long-term conservation of fiber structural materials, such as ancient leather objects.

### BACKGROUND OF THE INVENTION

As is well understood in the art, ancient leather objects are very sensitive to changes in environmental conditions, such as relative humidity (RH) fluctuations, because of their fragile structure. It should be understood that these objects are exposed to tensile stresses when the relative humidity alters, especially in parts undergoing high pressure or tension. This stress can cause breakage of the collagen fibers and crushing of the historical leather structure, ultimately wrinkling the leather. In other words, flexibility is a significant and desirable quality for leather objects, such as book covers. It should be understood that it is necessary for leather fibers to have enough flexibility for slipping over each other, which leads to better mechanical properties against the aforesaid tensile tensions, providing prolonged stability for the leather objects.

Since the 19th century, various lubricants have been proposed for usage on leather objects to increase their flexibility, improve their appearance and conserve their strength for long periods of time. It is known from the prior art that during the leather softening process, a lubricant is applied to the surface of the leather. This treatment can cause softening of the collagen structural fibers for slipping over each other, and, as a result, make the leather more flexible and softer. Nevertheless, as is well understood to those of skill in the art, this treatment has little or no preservative effect, and sometimes can even cause minor damage to the leather objects, such as by accelerating erosion reactions. Accordingly, although these lubricants are useful to forestall some physical damages, they are not effective against further chemical deterioration problems. Furthermore, as is well understood from the prior art, objects treated with the lubricants lose the aforesaid protective properties after almost three to five years.

As is understood in the art, various industrial lubricants are used in archives and libraries to protect leather objects, albeit without considering their effects on long-term protection ability. It should be understood that many of these industrial lubricants contain unknown ingredients. Therefore, these lubricants cannot be considered as reliable materials for the lubrication and conservation of ancient leather objects.

For example, it has been shown in the prior art that chestnut-tanned leather, treated by sulphonated cod-liver oil, wears faster than untreated leather. It is thus revealed in the prior art that using various lubricant materials on leather objects cannot protect them from further structural deterioration processes. However, a number of archivists agree that this treatment helps preserve the treated objects from dryness by making them a little softer in the hinges and spine. Nonetheless, Applicant has found that although the lubricant materials can induce better softening properties in the treated leather objects, the effect of these materials on the mechanical properties related to morphological fibrous structure is not significant.

There is, therefore, a present need for new and improved materials, compositions and manufactures to protect ancient leather objects for long periods under unfavorable conditions, without further damaging or degrading the delicate objects.

Nowadays, the use of nanoparticles in restoration science is proposed as a superseding method to conventional methods that merely focus on the treatment and not the preventive conservation. As is known from the prior art, nanoparticles would be effective in cleaning, de-acidification, consolidation and restoration of old objects, without also making the aforesaid limitations related with current lubricating materials as mentioned hereinabove. For example, the application of calcium and magnesium hydroxide nanoparticles for the de-acidification of paper artifacts is disclosed in the prior art.

Accordingly, in this invention, to overcome the above-mentioned limitations associated with the traditional lubricants and common treatment methods, a hydroxyapatite (hereinafter termed “HA”) and polyethylene glycol (hereinafter termed “PEG”) nano-composite is prepared through a simple method, and this treatment is consequently used for the conservation and protection of historical leather objects for prolonged periods against both physical and chemical degradations.

As is understood in the art, PEG is usually used on leather objects to conserve leather moisture, as well as being a softening agent. In addition, there is no report in the prior art about the negative effects of PEG when used simultaneously with other traditional lubricants. On the other hand, hydroxyapatite (HA) nanoparticles act as scaffoldings in tissues and interact with collagen filaments. These mineral particles consolidate the biological cells by connecting to the collagen. As a result, the advanced new nano-composite compound has both surface and structural conservative effects, simultaneously.

It is, therefore, an object of the present invention to present a novel nano-composite having preservative properties for fiber structural materials, especially to so preserve leather objects for prolonged periods.

It is also an object of the present invention to provide the aforesaid nano-composite through a simple two-phase mixing method.

Furthermore, it is an object of the present invention to apply the inventive nano-composite as an improved alternative for common lubricants. The aforementioned inventive nano-composite has deeper and more effective protective properties without further erosion effects such that mentioned herein above.

These and other objects are met in various embodiments of the present invention, offering significant advantages over the known prior art and consequent benefits in leather objects preservative techniques, treatments and compositions.

### SUMMARY OF THE INVENTION

The present invention relates to a nano-composite polymeric compound made of a polymeric base and a plurality of HA nanoparticles homogenously suspended in the polymeric base.

In a preferred embodiment of the present invention, a plurality of HA nanoparticles are homogeneously suspended in a PEG matrix to form a nano-composite polymeric compound which can be used as an improved alternative for common leather preservatives.

In one preferred embodiment of the present invention, the nano-composite is synthesized using a simple two-phase mixing method at ambient temperature providing the aforesaid nano-composite in an aqueous solution.

An embodiment of this present invention relates to the application of the aforementioned synthesized nano-composite for the conservation of fibril-structured materials, such as ancient leather objects. Hydroxyapatite (HA) acts as a scaffolding in tissues and interacts with collagen filaments. These mineral particles consolidate the bio cells by connecting to their collagen. The obtained nano-composite exhibits better properties and qualities in terms of structural strength, mechanical strain and flexibility. The method disclosed in the present invention enables a simultaneous increase in both the strength and the flexibility of the target leather objects. Furthermore, the disclosed nano-composite provides a higher protective effect for such leather objects against both physical and chemical degradations, while the commonly-known lubricants in the prior art are devoid of such advantageous features.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying DRAWINGS, where like reference numerals designate like structural and other elements, in which:

FIG. 1 is a transmission electron microscope (TEM) image of nano HA particles pursuant to an embodiment of the present invention;

FIG. 2 are scanning electron microscope (SEM) images at 15.00kx magnification presenting the collagen fiber of: (a) a “control” (or untreated) sample; and (b) an “optimum” (or treated by the produced HA/PEG nano-composite) sample pursuant to the teachings of the present invention;

FIG. 3 are elemental spectra and distribution (SEM-EDX) images representing the distribution of Calcium (Ca) in the: (a) “control” (or untreated) sample; and (b) “optimum” (or treated by the produced HA/PEG nano-composite) sample pursuant to the teachings of the present invention;

FIG. 4 are elemental spectra and distribution (SEM-EDX) images representing the distribution of Phosphorus (P) in the: (a) “control” (or untreated) sample; and (b) “optimum” (or treated by the produced HA/PEG nano-composite) sample pursuant to the principles of the present invention;

FIG. 5 is a diagram of the percent of the displacement versus temperature, for: (a) untreated; and (b) historical goat leather samples treated with the prepared nano-composite (HA/PEG) pursuant to the teachings of the present invention;

FIG. 6 illustrates the storage modulus curves of historical goat bookbinding leathers at 1 Hz versus temperature, for four samples: (1) an untreated sample, named as “control,” (2) a treated sample, named as “optimum,” (3) an untreated sample after artificial weathering aging, named as “aged control,” coded as “AC”; and (4) a treated sample after artificial weathering aging, named as “aged optimum,” coded as “AS”;

FIG. 7 shows tan(δ) curves of historical goat bookbinding leathers at 1 Hz versus temperature, for four samples: (1) an untreated sample, named as “control,” (2) a treated sample, named as “optimum,” (3) untreated after artificial weathering aging, named as “aged control AC,”; and (4) a treated after artificial weathering aging, named as “aged optimum AS”;

FIG. 8 illustrates differential scanning calorimetric (DSC) analysis curves for a “control” (or untreated) sample, and an “optimum” (or treated by the produced HA/PEG nano-composite) sample pursuant to the teachings of the present invention;

FIG. 9 is a chart representing the thermal decomposition of a “control” sample and an “optimum” sample pursuant to the principles of the present invention, illustrating a thermo-gravimetric analysis (TGA) curve for each sample, by weight and temperature;

FIG. 10 is a chart representing the thermal decomposition of a “control” sample and an “optimum” sample pursuant to the teachings of the present invention, illustrating a differential thermal gravimeter (DTG) curve for each sample, by weight and temperature;

FIG. 11 shows the differential scanning calorimetric (DSC) analysis curves for a “control” sample, designated by “HeatFlow AC,” and an “optimum” sample pursuant to the teachings of the present invention and designated by “HeatFlow AS,” after artificial weathering aging;

FIG. 12 is a chart representing the thermal decomposition of a “control” sample, designated by “AC,” and an “optimum” sample pursuant to the teachings of the present invention and designated by “AS,” illustrating a thermo-gravimetric analysis (TGA) curve for each sample, by weight and temperature; and

FIG. 13 is a chart representing the thermal decomposition of a “control” sample, designated by “AC,” and an “optimum” sample pursuant to the teachings of the present invention and designated by “AS,” illustrating a differential thermal gravimeter (DTG) curve for each sample, by weight and temperature.

### DETAILED DESCRIPTION OF THE INVENTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

It should be understood by a person skilled in the art that the innovation described herein is directed to the synthesis of a nano-composite polymeric compound and its application for long-term conservation of fiber structural materials, such as ancient leather objects, which are exposed to physical and chemical degradation.

In a preferred embodiment of the present invention, the nano-composite polymeric compound is composed of hydroxyapatite (HA) nanoparticles and polyethylene glycol (PEG), which Applicant has found has a synergic effect for leather conservation. Preferably, the polyethylene glycol (PEG) has a molecular weight in a range of about 200 to 800, and most preferably a molecular weight of about 400 (PEG400) is used for the nano-composite synthesis.

In a further preferred embodiment of the present invention, the nano-composite polymeric compound is synthesized through a simple, low temperature method, which has three steps: first, preparing a solution of PEG in deionized water; then, adding HA to the solution; and finally, vigorously stirring the resultant solution to obtain a semi-transparent and homogenous solution.

In one embodiment of the present invention, the concentration of PEG in the aforesaid PEG solution is preferably between about 15% to about 60% by weight.

In another preferred embodiment of the present invention, the HA nanoparticles are used as an aqueous solution with the concentration of HA nanoparticles being about 10% by weight in said solution. The aforementioned aqueous solution of HA nanoparticles constitutes about 0.1% by volume of the obtained nano-composite solution.

The morphology and dimensions of nanoparticles were observed by transition electron microscopy (TEM) after curing and dispersion through a nano-composite matrix. The TEM results demonstrated an average size of about 50 nm to 120 nm for the HA nanoparticles.

In some embodiments of the present invention, the preferred size of the HA nanoparticles is about 50 nm.

In another aspect of the present invention, the innovative nano-composite, synthesized as disclosed in the present invention, is used as an improved preservative for leather objects. A treatment method is used for ancient leather objects which has the following steps: first, the leather sample is immersed in the nano-composite solution disclosed herein, then, the samples are removed and dried and stored in a sealed condition.

The prepared nano-composite can be used for different leather types, such as goat leather, sheep leather, vegetable tanning leather, etc. Also, it can be used in parchment lubrication and conservation treatments.

The effect of the aforementioned nano-composite disclosed in the present invention on historical leather consolidation, both in static and dynamic modes, as well as at low and high domains of strain, can be appraised by tensile test and dynamic mechanical thermal analysis (DMTA), respectively. A number of correlations between tensile test and DMTA results are devised. In addition, the structural and morphological changes of the treated samples are studied by the SEM method. Furthermore, the thermal analysis of the treated leather is carried out through the aforementioned thermo-gravimetric (TGA) and differential thermal gravimeter (DTG) analyses. Also, with the purpose of studying the phase modifications of collagen, the aforementioned differential scanning calorimetric (DSC) analysis is applied as a preferred method to study the response of the leather to denaturing or to preservation treatments.

The above characterization and analysis methods applied in the present invention and generally obtained results are described in more detail hereinbelow.

### Tensile Test

It should be considered that adequate pliability is a very important quality requirement for certain leather products, which provides both comfort and a good “handle” for use. The quantitative assessment of pliability, or its reverse term “stiffness,” can be based on measurements of the resistance to a small deformation by tensile stress. The resistance may be quantitatively represented best by the initial slope of load-displacement curves or stress-strain curves in an elastic deformation region. The main objective of using lubricants (such as fat liquors) in the leather-making process is to provide flexibility and compliance for the collagen fibers in the leather.

Herein, tensile tests confirmed that treatment with the aforementioned HA/PEG nano-composite according to the present invention promoted the movement of collagen fibers and decreased the frictional resistance of the fibers. This reduction in friction led to more softness and an increase in tensile strength.

### Dynamic Mechanical Thermal Analysis (DMTA)

Viscoelastic properties of historical leather can be studied by dynamic mechanical thermal analysis (DMTA) at a fixed frequency over a specific temperature range under sinusoidal mechanical deformations (or forces). The measured DMTA parameters are the storage modulus E″, the loss modulus E″, and the loss factor tan (8), which represents the mechanical damping. The changes in displacement under a static load can also be measured by DMTA, which is a sensitive technique in detecting thermal transitions corresponding to molecular movements in polymeric chain.

In addition, hydrothermal structural stability of leather can be characterized by its shrinkage when it is heated in water. The temperature at which fully hydrated material shrinks under definite conditions is called the shrinkage temperature (Tₛ). The Tₛ value depends on the raw material, the methods of tanning, and the deterioration degree which the leather has undergone during its lifetime. Recently, DMTA techniques have been used for the determination of Tₛ from historic or cultural artifacts. Smaller samples are required for this test in comparison with other analysis methods, which is an advantage of this technique. Studies have shown the shrinkage behavior in tensile mode of leather and parchment by measuring the changes in sample displacement as a function of time and temperature. These results showed that the un-aged leather sample had a longer shrinkage and drying time than the aged sample and a smaller initial displacement.

The results obtained by DMTA show that the treated samples were softer than untreated samples even at elevated temperatures.

### Scanning Electron Microscopy (SEM-EDX)

Herein, the morphology of the grain surface and fracture surface of the samples were observed by scanning electron microscopy. Scanning Electron Microscopy (SEM) techniques have been employed to observe the fracture surface of historical leather as well as the nano-composite treated leather pursuant to the instant invention.

A Scanning Electron Microscopy—Energy Dispersive X-ray Spectroscopy (SEM-EDX) of the samples illustrated the penetration of nanoparticles in the leather substrate and their attachment on the collagen fibers. Moreover, the collagen filaments of the treated sample were thicker than those belonging to untreated samples. This means that the nano-composite induced a plasticizer quality and decreased the interaction of the filaments in slip and tensile state. Also, the calcium and phosphorus mappings by the EDX analysis in treated samples show the uniform distribution of these elements in the leather substrate.

### Differential Scanning Calorimetric (DSC) Analysis

It should be considered that the deterioration of leather is explained as a transformation from the triple helix to a random coil, accruing in the areas between the cross-links. The super helix is strengthened by hydrogen bonds, hydrophobia, van der Waals interactions and also interaction between side chains. In addition, hydrogen-bonded water takes a significant role in the firmness of the molecule. These non-covalent links that decompose through heating result in an increase in the covalent bonds and cross-link intramolecularly, ultimately inducing a denature temperature (T_{d}) shift toward higher temperatures range. This happens on aging, cross-links, the rupture of intra- and internal sequence H—bonds and arrangement on new hydrophobic links in the random coiled form. During the past decades, thermal studying techniques, such as differential scanning calorimetric (DSC), thermo-gravimetric analysis (TGA), etc., were employed in the investigation of old leather and parchment. The analysis curves resulting from the aforesaid techniques enable one to roughly determine the age and state of leather.

The aforementioned thermal analyses have been adapted for the investigation of thermal behavior of some collagen based materials (i.e., pure collagen, new parchments and tanned leathers; and old parchments and leathers) in water, nitrogen, oxygen and synthetic air flow with continuing heating in a temperature range of about 25° C. to 269° C. In the case of the N₂ gas flow, all the prepared samples pursuant to the present invention show two main phases, correlated with the dehydration and melting. Recently, the progress of the aforementioned analytical techniques was achieved by assembling a material using sample amounts in a range of about 1 mg to 5 mg.

The DSC method determines the “melting” temperature of the crystalline constituent of collagen—based materials flow as a consequence of natural aging of leather, the conservation situation and their deterioration extent. In addition, DSC enables the analysis regarding the real structure of collagen, and how the molecules join to tannin and other materials.

DSC analysis results have confirmed that in an untreated sample, a glass transition, melting phase occurred at higher range temperatures than those corresponding to a treated sample, meaning that the amorphous structure is stiffer than the treated sample. Similarly, aged, treated samples show more softness than an aged untreated sample.

### Thermo Gravimetric Analysis (TGA) and Differential Thermal Gravimeter (DTG)

It should be understood that the thermo-gravimetric analysis (TGA) includes the calculation of the combination change of a sample while it is subjected to a heating system. In this method, measurements are carried out under a specified gas flow in isothermal and non-isothermal (linear heating flow) conditions. New apparatus enable using quite small sample amounts of a few mg, even less than 1 mg, making the TGA analysis preferred methodology for the study of old objects, which is a subject of the present invention.

Furthermore, the aforesaid analyses provide the numerical modifications of thermo-gravimetric (TG) curves. As it will be demonstrated in a “TG/DTG” section hereinbelow, the obtained DTG data provide knowledge about historical leather degradation. The combination of DSC and TGA methods, pursuant to the present invention, enable one to determine the inclusive damage and phase changes. In one embodiment of the present invention, laterally-obtained information was confirmed by the DSC results, showing the improving changes caused by the treatment with the nano-composite of the present invention.

The obtained results from the aforesaid TGA and DTG analyses in N₂ flow reveal that the untreated sample has more water content lost and more structural changes in progressive temperature than the treated sample. Also, the aged untreated leather lost more water content in progressive temperatures and had more weight changes than the aged treated sample. In addition, it is confirmed that the flexibility and strength of the collagen filaments in the treated sample are better than those of the untreated sample even after aging.

Exemplary techniques for the production of the HA/PEG nano-composite pursuant to the teachings of the present invention, and its use in leather conservation treatments pursuant to the present invention are set forth in more detail hereinbelow. It should be understood that these examples set forth herein are illustrative only, and similar techniques for the production and application of the preferred nano-composites of the present invention are thus possible with different parameters, as is understood in the art. The examples should not be deemed as limiting the scope of the present invention. The only limitations of the scope of the instant case are set forth in the claims appended hereinbelow.

### Example 1

### Synthesis of the HA/PEG Nano-Composite

In this example, a HA/PEG nano-composite pursuant to the teachings of the present invention is produced via the dispersion of HA nanoparticles in a two-phase mixture. Accordingly, polyethylene glycol, with a preferred molecular weight of about 400, and nano-hydroxyapatite in a water suspension were obtained. Firstly, a 10 ml solution, with a PEG content of about 15% by volume in deionized water, was prepared and then about 0.1 ml of a 10% wt HA aqueous suspension was added to it. The resultant two-phase solution was vigorously stirred at a rate of about 240 rpm for about 30 min at ambient temperature by a magnetic or other stirrer, until the solution became semi-transparent and homogenous.

With reference now to FIG. 1 of the DRAWINGS, there is shown a transition electron microscopy (TEM) image of hydroxyapatite particles, such as used in practicing the principles of the present invention. This image confirms that the hydroxyapatite particles' dimension remains at nano-scale, between about 50 nm to 120 nm, after curing. This illustrative TEM image shows that the size of a majority of the particles is about 50 nm. Therefore, it can be concluded that no agglomeration of particles has occurred in the solution before the coating. Other samples have similar distributions.

### Example 2

### Historical Leather Treatment by the HA/PEG Nano-Composite

In this embodiment example, a type of historical goat leather of a book cover from the Qajar era (19^{th} century) with vegetable characterization tanning and hand coloring was obtained. A piece of the aforesaid leather was used as the “control” sample, designated herein as “control.” For nano-composite treatment, a rectangular form of the historical leather sample is placed in the nano-composite solution, prepared according to the procedure described in connection with EXAMPLE 1 hereinabove, under magnetic stirring for about 15 min at room temperature. Then, it was removed from the solution and then, the treated leather surface was softly dried by a soft cloth and stored in a desiccator at room temperature for about one week before mechanical and thermal testing. In addition, the samples were conditioned in the test room at 23° C. and 50% relative humidity (RH) for 24 hours before mechanical property testing. A piece of the treated leather sample (designated herein as “Optimum”) was used for the following analyses.

### SEM Analysis

An SEM technique was employed to observe the fracture surface of the historical leather treated with the nano-composite. The fracture surface was provided by the temperature of liquid nitrogen and the samples were coated with a thin layer of gold having a thickness of about 15 nm and a density of 19.32 g/cm³. The distributions of Ca and P atoms, as well as other elements in the EDX spectra on the leather substrates, were obtained by SEM-EDX mapping.

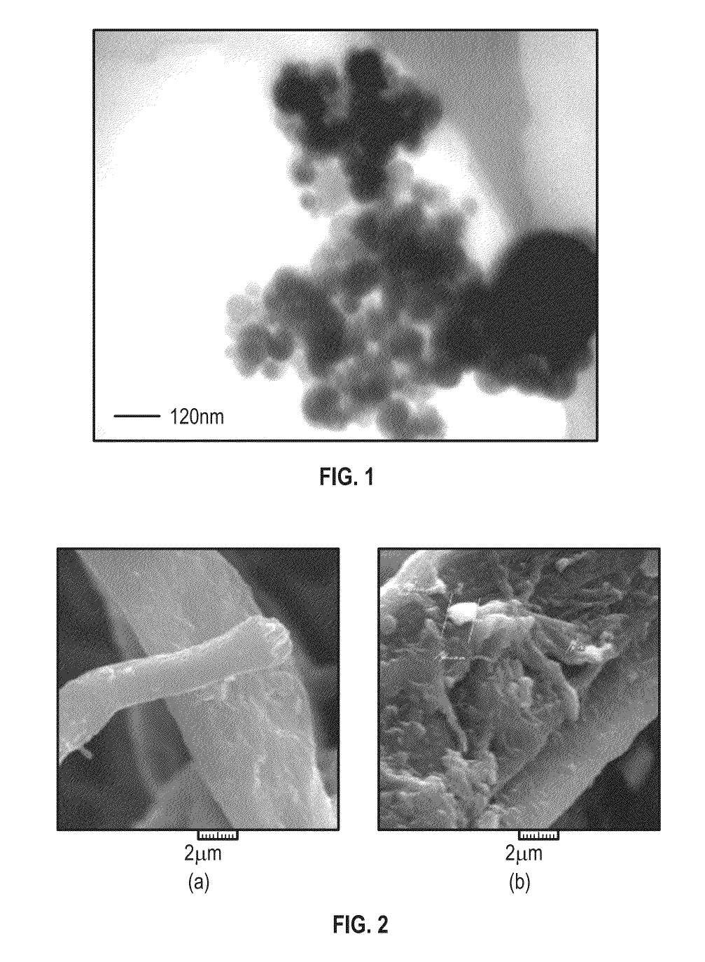

With reference now to FIG. 2 of the DRAWINGS, this figure shows SEM micrographs of the collagen fibers belonging to the aforementioned “control” and the “optimum” samples.

The collagen filaments, cell attachment and distribution of the nano hydroxyapatite crystals on collagen fibers can be seen in these images. By comparison of the SEM images of collagen filaments for the “control” and “optimum” samples in the same magnification, as illustrated in FIGS. 2a and 2b, respectively, an increase in fiber thickness is observed for the treated sample. This can be attributed to the absorption due to humidity, accompanied by the penetration of the PEG in the fibril structure. Also, the PEG present in the leather can act as a plasticizer and a lubricating agent. On the other hand, the hydroxyapatite nanoparticles rest between collagen filaments as globules and decrease their interactions in slip and tensile state.

The presence of HA nanoparticles on the collagen fibers indicates good penetration of these particles into the leather structure. In addition, the attachment between the HA particles and the fibers can be due to electrostatic interactions of the mineral phase, Ca⁺² from hydroxyapatite, on the organic phase (carboxyl groups of collagen at the sample).

### SEM-EDX Mapping

The elemental spectra and distribution of calcium (Ca) and phosphorous (P) atoms at the fracture surface of the nano-composite leather sample (i.e., “optimum”) and untreated leather (i.e. “control”) was characterized by SEM-EDX mappings.

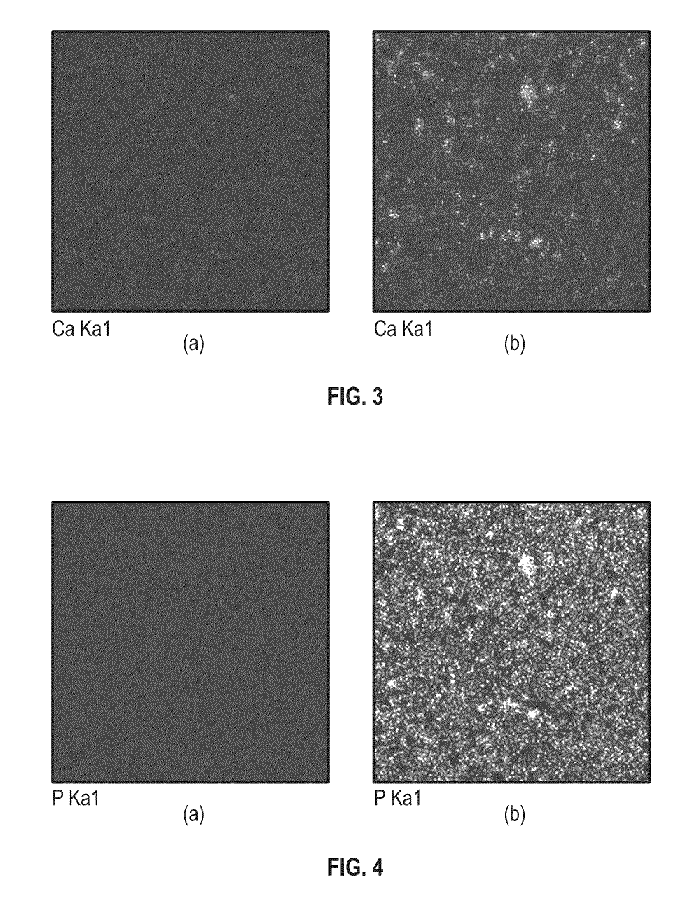

With reference now to FIGS. 3 and 4 of the DRAWINGS, these figures present the calcium and phosphorous maps in which Ca and P atoms are denoted by white points in “control” and “optimum” leather samples. As seen from these images, the calcium particles (designated by white points) have uniform distribution and are more condensed in the treated leather (i.e. “optimum”) compared with the untreated historical leather (i.e. “control”). The “control” sample does not indicate any existence of phosphorous atoms in the fracture surface, while it is uniformly distributed in the “optimum” sample. Therefore, it can be concluded the HA nanoparticles are uniformly distributed in the “optimum” sample.

### Tensile Test

In the present invention, tensile test measurements were recorded using a tensile machine at a crosshead speed of 2 mm min⁻¹ at room temperature; with load cell of 60KN. Tensile samples were prepared as dumbbell-shaped specimens having 35 mm×7 mm×0.5 mm dimensions.

The tensile property measurements, including yield strength, ultimate strength, and Young's modulus for the aforesaid “control” and “optimum” samples obtained from their stress-strain curves, are set forth and presented in TABLE 1, hereinbelow.

TABLE 1
The tensile properties of leather samples

| | Yield | Strain at | Ultimate | | Young’s |
|---|---|---|---|---|---|
| | strength | yield point | Strength | Strain at | modulus |
| Samples | (N/mm²) | (%) | (N/mm²) | Break (%) | (N/mm²) |
| “control” | 6.43 | 21 | 6.08 | 25 | 1.88 |
| “optimum” | 9.85 | 35 | 9.25 | 39 | 0.93 |
| “AC” | 4.46 | 19 | 3.96 | 21 | 1.73 |
| “AS” | 5.64 | 34 | 5.19 | 36 | 1.66 |

By comparison of the “control” and “optimum” samples results set forth in TABLE 1 hereinabove, the yield and ultimate strengths, as well as the strain at yield and strain at break, were increased while the Young's modulus decreased in the “optimum” sample. This means that the mechanical properties and the surface area under a tensile-elongation curve was improved by the HA/PEG nano-composite treatment. These results confirm that the treatment with the HA/PEG nano-composite of the present invention promoted the movement of collagen fibers, and decreased the frictional resistance of the fibers. This reduction in friction led to more softness and an increase in tensile strength.

### DMTA Analysis

In the present invention, the DMTA measurements were performed using DMTA equipment on rectangular samples, which were (5 mm×5.5 mm×0.5 mm) mounted in the tensile mode between 0° C. to 250° C. at 3 Kmin⁻¹ under a controlled strain (0.2%) and 0.3 N static force, at 1 Hz frequency, in a static air environment.

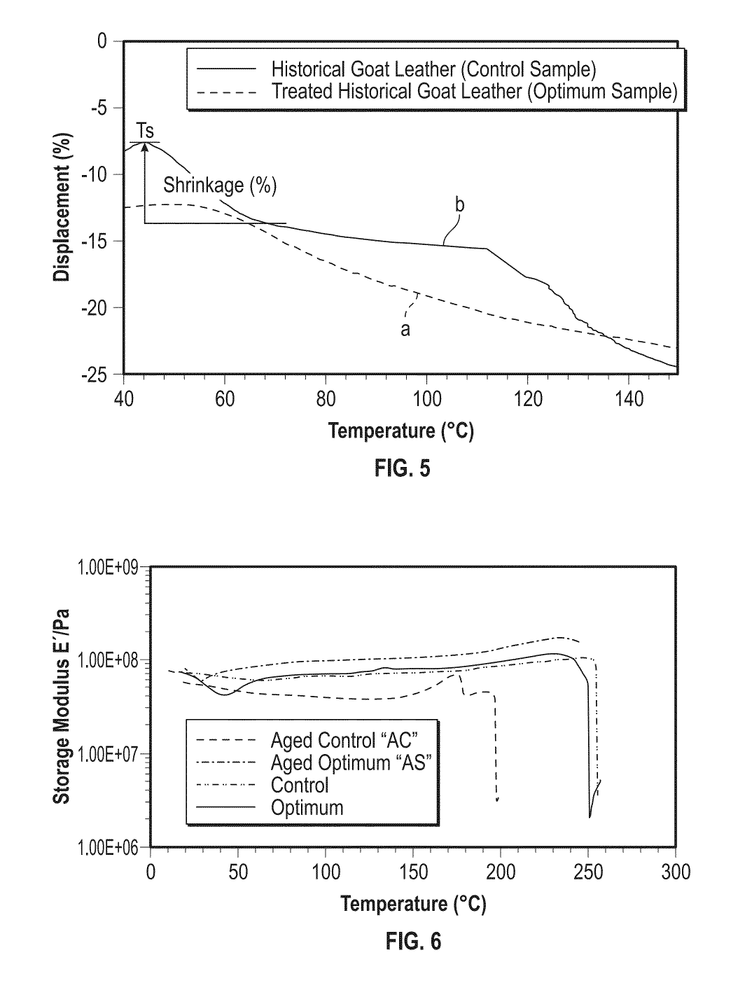

With reference now to the FIG. 5 of the DRAWINGS, this figure illustrates the values of displacement recorded as a function of temperature for untreated and treated historical goat leathers obtained by DMTA analysis. It was possible to calculate the values for the shrinkage temperature (Tₛ) as well as the amount of shrinkage, from values of displacement versus temperature curves. The untreated sample showed a higher shrinkage temperature (Tₛ) than the treated sample, while the initial displacements are the same for both samples.

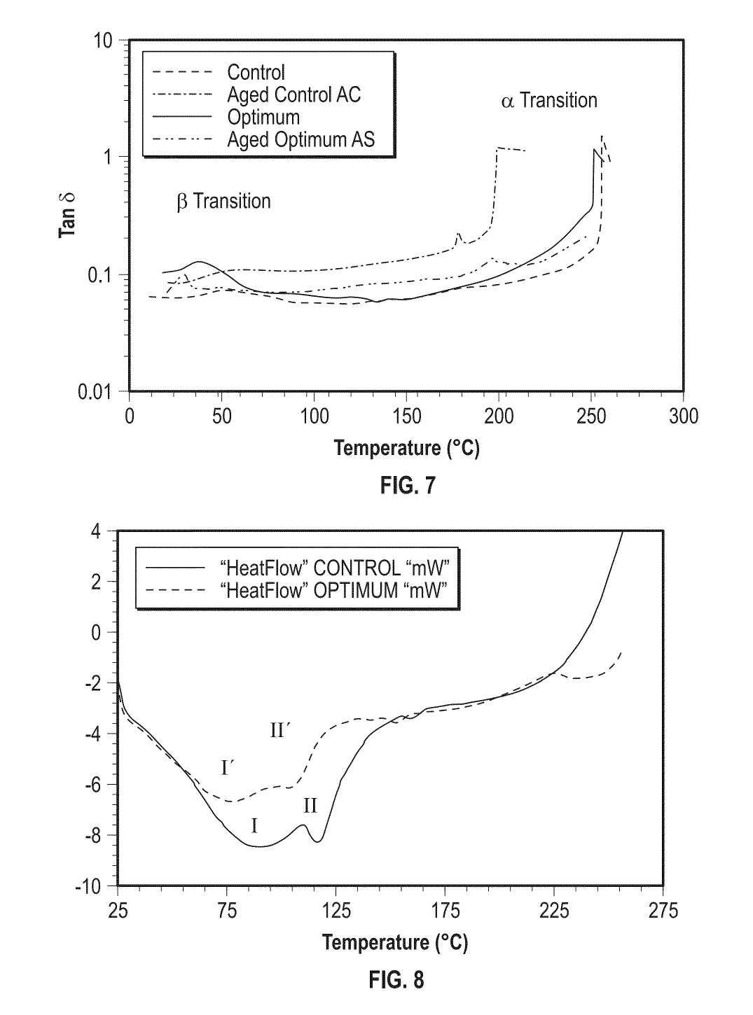

With reference now to FIGS. 6 and 7 of the DRAWINGS, these figures illustrate the storage modulus (E′) and loss factor (tan (8)) curves for the “control,” designated with the aforenoted “AC,” and “optimum” samples, designated with the aforenoted “AS,” respectively, as a function of temperature at 1 Hz.

It has been reported in the prior art that changes in the modulus are related to the moisture content of the samples and not to the drying temperature. A typical DMTA behavior of a vegetable-tanned leather within the temperature range of about −100° C. to 300° C. shows three major viscoelastic transitions, whereby the peaks are suggested to be the 8 and 8 shrinking-related transition and the glass transition, respectively. According to another study on viscoelastic behavior of new and historical leathers in tensile mode, a major melting process above 200° C. was exhibited.

Herein, by comparison of the storage modulus (E′) and loss factor (tan (8)) of the leather samples versus temperature at progressive heating, the following information can be obtained: (1) an initial decrease of E′ followed by a slight increase and a large plateau; (2) a continuous increase of the storage modulus at around 230° C.-250° C.; and (3) a drop of two orders of magnitude in the storage modulus E′. The first part of the curves is due to moisture loss. The abrupt decrease of modulus at temperatures above 200° C. is attributed to the melting of the crystalline fraction of collagen. The inflexion point of this decrease of the storage modulus, (indicated before as Tₛ), was used to estimate the melting temperature of the samples. In this study, T_{storage} was found to be 253° C. for historical leather, i.e., “control,” and 241° C. for treated leather i.e., “optimum.”

As shown in the figures, the tan (δ) curve dependence on temperature for the leather samples indicated the following trends: a broad and weak peak at about 30° C.-70° C., a continuous increase to about 200° C., and a very sharp peak at about 250° C. The comparison of the obtained results shows that the treated historical leather, i.e., “optimum,” exhibits a viscoelastic behavior similar to historical leather while it has less stiffness and higher viscoelastic behavior from room temperatures up to 70° C. However, historical leather, i.e., “control,” has a higher melting temperature than treated leather, i.e., “optimum,” which could be due to either cross linking occurring or natural aging.

On the whole, the nano-composite treatment of the historical leather can induce storage modulus curves of “control” and “optimum” to show similar features at higher temperatures and less stiffness and viscoelastic behavior up to 70° C., which means that the treated leather is softer than the “control” sample even in progressively increasing temperatures.

The decrease in the storage modulus of the “optimum” sample and the increase in tan (δ) amplitude and shifting to lower temperatures may be attributed to the formation of hydrated collagen fibers and (HA) nanoparticles which act like spacers between the collagen chains in the leather matrices, which in turn reduces the interchain interactions. This suggests that the lubricating of leather with HA and PEG improves the mechanical properties.

### DSC Analysis in N₂ Flow

In the present invention, differential scanning calorimetric (DSC) thermal measurements were performed using a DSC calorimeter apparatus. The samples with amounts of about 10.5±0.2 mg were heated at the constant rate of 10 K min⁻¹ from 20° C. to 350° C. in open aluminum pans and nitrogen flow (50 ml min⁻¹, nitrogen purity of 99.999%).

It should be understood that all samples were stored in sealed crucibles in the test room at 23°±2° C. and RH 50% for one week before any analysis. Therefore, any release of matter is prevented, and thus the moisture content of the sample remains constant over the entire measurement temperature range. Therefore, the DSC results are related to the thermal denaturation only.

With reference now to FIG. 8 of the DRAWINGS, there are illustrated therein DSC curves for the aforementioned “control” and “optimum” samples. The analysis of all data obtained by DSC analysis in N₂ flow is summarized and set forth in TABLE 2 hereinbelow, illustrating the glass transition temperature (Tg) and the minimum temperature of endothermic peaks (I and II), as indicated in FIG. 8.

As shown in FIG. 8, the glass transition temperature of the “control” sample occurs at higher temperature in comparison with the “optimum” sample. This indicates that the value of Tg for historical leather decreases by the treatment with PEG and nano HA aqueous solution. This may be attributed to the movement of amorphous chains of collagen due to an increase in their volumes because of water absorption, as revealed by the SEM results illustrated in FIG. 1 of the DRAWINGS, and discussed in more detail hereinabove. In addition, the nano hydroxyl apatite particles are placed between the collagen chains, increasing free volume, facilitating the movement of the amorphous sections, and consequently inducing a decrease in the glass transition temperature (Tg).

TABLE 2
The data of the DSC analysis

| | | Glassy | Minimum | Minimum |
|---|---|---|---|---|
| | | transition | temperature | temperature |
| | Leather | temperature | of peak I | of peak II |
| group | samples | Tg (° C.) | (° C.) | (° C.) |
| Unartifical | “control” | 55/07 | 80/93 | 155/02 |
| aged | “optimum” | 40/74 | 73/1 | 148/721 |
| Artificial | “AC” | 44/18 | 64/42 | 215/37 |
| aged | “AS” | 41/26 | 63/96 | 202/73 |

According to the endothermic peaks set forth in TABLE 2 hereinabove, at a relative low temperature, each investigated sample exhibited a wide endothermic peak, denoted by I, corresponding to the loss of humidity. This process is followed by one or some smaller endothermic peaks, denoted by I′ and I″ in FIG. 8. Immersion of the “optimum” sample in the aqueous HA/PEG solution can be induced at higher hydration level in relation to the natural aged sample (i.e., the aforesaid “control”). Therefore, the endothermic processes occurring between room temperature and about 120° C. can be related to the vaporization of the adsorbed and absorbed residual water. In addition, the immersion of the leather in a nano-composite aqueous solution induces decreasing minimum temperatures of peak I and I′ to the lower temperatures in the “optimum” sample. With a further reference to FIG. 8 of the DRAWINGS, it is illustrated in this figure that the endothermic process I can be displaced to lower temperatures for the “optimum” sample compared with the “control” sample.

With further reference to FIG. 8 of the DRAWINGS, the second endothermic process (process II) could be explained by the biphasic, amorphous-crystalline structure of collagen-based materials, according to which the crystalline triple-helix is embedded into an amorphous-matrix (protein denaturation). Consequently, process II might be related to the softening (melting) of the crystalline part of the material.

In the “control” sample, phase melting occurs at higher temperatures in comparison with those corresponding to the “optimum” sample, revealing a stiffer amorphous structure in the control sample, which could be explained by the above-mentioned biphasic, amorphous-crystalline structure, collagen-based materials, where the softening of the crystalline part is hindered by the rigidity of the amorphous matrix. It seems that PEG induces more softness in the “optimum” sample because of the absorption of the environmental humidity as per its characteristics. In addition, the mineral HA nanoparticles are hydrophilic, which can increase the aforementioned property.

It should be understood that the melting temperature (Tₘ) values are influenced by both the different leather preparation procedures and by the various environmental conditions of stocking and exposure. Therefore, the temperature related to the softening (melting) process could be used only as a qualitative criterion to differ between new and old leathers.

With further reference to FIG. 8, it can be seen that denaturation peaks are sharp and narrow, and reach their maximum at about 120° C. In N₂ gas flow, a broad endothermic ranging from room temperature to about 130° C. is the experimental evidence of two overlapping processes, moisture loss and collagen thermal denaturation. Thermal denaturation cannot thus be evaluated, but transitions related to softening/melting of the collagen crystalline fraction, as well as thermal oxidation, can be detected at higher temperatures.

Immersion of the “optimum” sample and its DSC measurement were carried out for qualitative evaluation of deterioration, since it is at higher hydration levels compared to the natural aged samples, as mentioned hereinabove. In this condition, collagen fibrils are swollen in water, which is divided into two phases: intrafibril and external water. Furthermore, water addition merely increases its presence in the external pool without affecting the intrafibril water or interaxial molecular spacing of collagen molecules in the fiber lattice. By contrast, at intermediate hydration levels, as for so-called wet samples, results may be less reliable, since DSC parameters can vary with the collagen hydration level.

Highly cooperative structures, such as proteins, stabilized by the cooperation of numerous weak forces (e.g., hydrogen bonding, electrostatic and hydrophobic interactions, etc.) undergo thermal transitions resulting from changes in conformation, hydration/dehydration, denaturation, aggregation, de-aggregation, and oxidation. Thermal denaturation is a time-dependent, irreversible transformation of the native triple helical structure into uncoiled structures regardless of the underlying molecular mechanisms; and collagen heating gives rise to sharp endothermic peaks at defined temperatures, Tₘₐₓ, depending on the hydration level as shown in FIG. 8. DSC peak temperature has been assumed as the denaturation temperature of the collagen within the parchment. The higher denaturation temperature for the same sample measured in static air is mainly due to the higher crosslink content and fibril cohesion.

### Tga-Dtg Analysis in N₂ Flow

It should be understood that the shrinkage phenomenon is the main heat damage in the collagen network coupled with some water loss. Herein, TGA analysis was used to quantify the extent of the water loss and DTG curve of the samples was studied for better interpretation of the TGA data.

In the present invention, the TGA and DTG curves were recorded using TG apparatus. The samples were weighed (9±1 mg) and then heated at a constant temperature-increasing rate of 10 K min⁻¹ in gas flow (Nitrogen; purity of gas in higher than 99.999%; 50 ml min⁻¹) in a temperature range of 20° C. to 600° C.

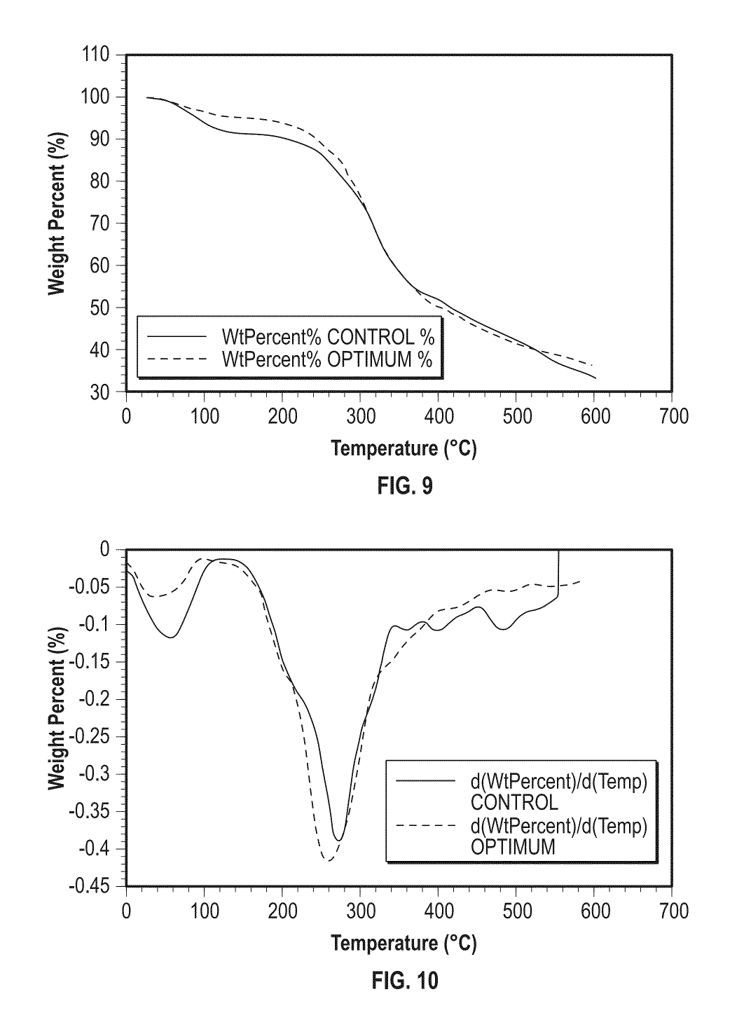

With reference now to FIGS. 9 and 10 of the DRAWINGS, these figures show the TGA-DTG curves obtained by analysis in N₂ flow for the aforesaid “control” and the “optimum” samples. The “control” sample here exhibits melting phase at the temperature range of about 154° C. to 169° C., whereas it occurs for the “optimum” sample in a range of about 136° C. to 165° C.

The initial slope in the TGA curve of the “control” sample is sharper than those corresponding with the “optimum” sample, which means that the “control” sample has lost more water content in progressive temperature heating compared to the “optimum” sample.

With further reference to the DTG curve shown in FIG. 10 of the DRAWINGS, it is observed that the first peak related to water content loss is sharper for the “control” sample compared to the “optimum” sample, also the second peak, which is related to the leather structure denaturing, is broader for the “control” sample. Applicant contends that this means that the “control” sample shows more structural changes in comparison with the “optimum” sample. Furthermore, in the “control” sample, the temperature at which the maximum weight loss occurred is lower than that of the “optimum” sample.

The obtained data from the TGA-DTG analyses are set forth and presented hereinbelow in connection with TABLE 3.

TABLE 3
The obtained data from the TGA-DTG analysis

| | The temperature of the | The temperature of | Stopping |
|---|---|---|---|
| | maximum weight | the melting | temperature |
| samples | losing (° C.) | phase (° C.) | (° C.) |
| “control” | 266 | 154 - 169 | 599 |
| “optimum” | 267 | 136 - 165 | 600 |
| “AC” | 328/87 | 198 - 228 | 600.26 |
| “AS” | 330/23 | 180 - 217 | 600.55 |

### Example 3

### Aging Procedure

In this example, the structural changes during the time lapse for the “control” and the “optimum” (treated by the aforenoted HA/PEG nano-composite) samples are investigated through an accelerated aging procedure. Accordingly, two pieces of the leather samples are prepared pursuant to the method described in EXAMPLE 2 (designated as “control” and “optimum”), and were artificially aged in a chamber for 1000 hours. The samples were then exposed to a cyclic test: first, 16 hours at 40° C. under a relative humidity of 80%, a first cycle at substantially room temperatures and high humidity, followed by 8 hours at 15° C. under a relative humidity of 5%, a second cycle at lower than room temperatures and low humidity, and a UV radiation treatment provided by an ultraviolet B (UVb) lamp with a power of 8 W. Accordingly, the obtained artificially-aged “control” and “optimum” samples were coded as “AC” and “AS,” respectively. The obtained samples were analyzed by the same methods according to those described in previous example (i.e., EXAMPLE 2), hereinabove.

### Tensile Test Results

The tensile property measurements, including yield strength, ultimate strength, and Young's modulus for the “control” and the “optimum” samples after the accelerated ageing test, obtained from the stress-strain curves are presented and set forth in TABLE 1 hereinabove.

It can be seen from TABLE 1 presented hereinabove, that the artificially-aged “optimum” samples, i.e., “AS,” had better tensile properties in comparison with the “control” aged, i.e., “AC,” sample. However, a general reduction in the tensile properties is observed after the artificial aging process, as compared to the similar results for un-aged samples (i.e., “control” and “optimum”).

The increase of the strain quality in “AS” in comparison with the “control” and “AC” can be attributed to the nano-composite treatment effect. The HA nanoparticles can be considered as spherical balls, which are placed between collagen chains to ease their slipping over one another. This treatment promotes the movement of collagen fibers and decreases the frictional resistance of fibers when leather is subjected to a tensile force. The reduction of friction leads to a more uniform stress distribution in stretched leather and consequently leads to an increase in tensile strength.

### DMTA Analysis Results

The storage modulus (E′) and loss factor (tan (δ)) curves of the aged samples (i.e., “AC” and “AS”) are illustrated in FIGS. 6 and 7 of the DRAWINGS as a function of temperature in 1 Hz. Accordingly, the value of Tstorage (Tₛ) is 247° C. and 197° C. for “AS” and “AC” samples, respectively.

With further reference to FIGS. 6 and 7, there is observed an exception behavior for artificial aged untreated historical leather, i.e., “AC” in both storage modulus (E′) and loss factor (tan (δ)) curves, compared with the treated historical leather, i.e., “AS” and also the un-aged samples (i.e., “control” and “optimum”) analyzed in the previous example hereinabove. The obtained storage modulus (E′) curve for “AC” exhibited two shoulders at about 177° C. and 196° C., while the “AS”, “control” and “optimum” samples show a continuous increase of storage modulus at around 230° C. to 250° C.

As mentioned hereinabove in connection with EXAMPLE 2, the tan(8) curve dependence on temperature for the leather samples indicated a broad and weak peak followed by a continuous increase to about 200° C., and a very sharp peak at about 250° C., which occurs for the “AC” sample at about 200° C. The comparison of the obtained results shows that the treated leather after the artificial aging process, i.e., “AS,” shows the same E′-T feature as the “optimum” and the “control” samples with a shift of E′ to higher amounts and a displacement of 8 relaxation peak to a lower temperature and amplitude. In addition, artificial aging increases its melting temperature from 241° C. to 247° C.

The explanation of the viscoelastic behavior of the “AC” sample is quite difficult due to the complexity of the degradation processes, the heterogeneity of the samples and the unknown previous preservation treatment. The shapes of the E′ vs. T curve of the “AC” sample represents a viscoelastic behavior similar to the historical leather, while it has a shift of E′ to a smaller amount and two lower melting temperatures compared to the historical leather, i.e., the “control” sample. These shifts can be related to various levels of the deterioration, which are related to the artificial aging process or heterogeneity of the samples. Artificial aging of the leathers can affect collagen and the non-collagen components of the leathers (tannins, oils, etc.) due to their oxidative and hydrolytic degradation, as shown, for example, by the decrease of tannin extracts for old leathers in comparison with the new samples. These results are confirmed when fibrils and bundles come closer, resulting in a more compact and rigid network.

### DSC Analysis in N₂ Flow

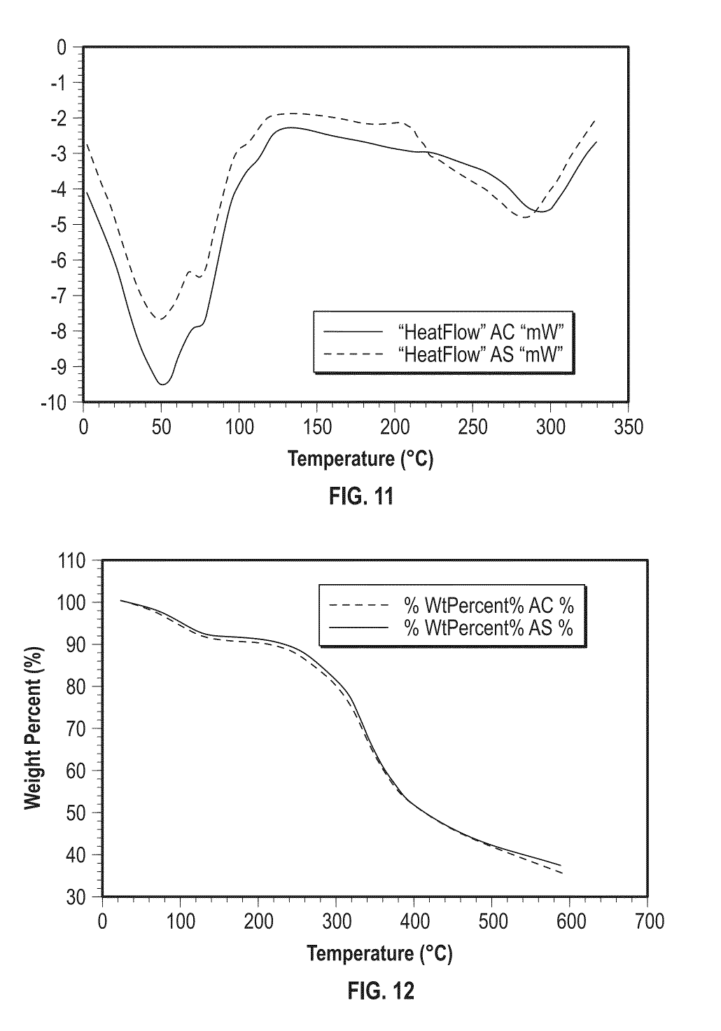

With reference now to FIG. 11 of the DRAWINGS, this figure shows the DSC curves for the untreated historical leather and the historical leather immersed in nano HA/PEG aqueous solution after artificial aging, as per the present invention. The analysis of all data is summarized in TABLE 2, as set forth hereinabove.

It could be observed that the glass transition temperature of the “AC” sample occurs at a lower temperature in comparison with the “control” sample. This indicates that Tg decreases as a result of the artificial aging, as well as the treatment with HA/PEG nano-composite solution, as discussed hereinabove.

As was seen in FIG. 8 of the DRAWINGS, the endothermic process I can be displaced to lower temperatures for the “optimum” sample compared with the “control” sample, while with reference to FIG. 11 of the DRAWINGS, both samples (“AC” and “AS”) exhibit a similar trend after artificial aging. In addition, the minimum peak temperatures of process I occur at a lower temperature in comparison with the aforesaid “control” and the “optimum” samples. This may be attributed to the stable hydration levels in the artificial aged samples.

Melting phase occurs at higher temperatures for the “AC” sample compared to the “AS” sample, meaning a softer amorphous structure for “AS”. It seems, therefore, that PEG induces more softness in the “AS” sample, as well as the “optimum” sample, by absorption of the environmental humidity and by its structural characteristics. Also, the hydrophilic mineral HA nanoparticles intensified this effect.

With further reference to FIGS. 8 and 11, it is illustrated that the melting temperature (Tₘ) values in the case of the aged samples (“AC” and “AS”) are higher than those corresponding to the “optimum” and the “control” samples because the ageing process induces heterogeneity in the structure of the crystalline region. As was mentioned hereinabove, the melting temperature (Tₘ) values are influenced by different leather preparation procedures and by various environmental conditions in stocking and exposure. Therefore, the temperature related to the softening (melting) process could be used only as a qualitative criterion to differ between new and old leathers.

Accelerated ageing treatments resulted in distinct variation patterns for DSC parameters depending on the ageing factors and hence on the induced deterioration mechanisms. At high hydration levels, the multiple character of DSC curves is resolved (as illustrated in FIG. 11 of the DRAWINGS) and multiple peaks can be singled out by the appropriate DE convolution. As a consequence, besides their excellent reproducibility, measurements in excess water offer a more comprehensive evaluation of thermal denaturation of parchments. DSC parameters of the thermal denaturation in excess water were therefore selected for the quantitative evaluation of the damages and the stability of the parchments. The large collection of DSC parameters obtained for the parchments exposed to various accelerated ageing treatments enabled us to set up a deterioration scale ranking parchments in four damage classes (no damage, minor, medium and major damage).

Alteration of DSC full peak on ageing/deterioration determined from its shifting, broadening and shortening with respect to reference is an indication of increasing heterogeneity of the distribution of the collagen populations with different thermal stability. Their separation is obtained by convolution of full DSC peak. New parchments display up to three components: a minimum at T\Tₘₐₓ, a main transition peak at Tₘₐₓ, and a shoulder at T [Tₘₐₓ]. These peaks are associated with labile, stable and cross-linked collagen populations, respectively. Quantification of the collagen populations with distinct thermal stability is given by the enthalpy associated to the corresponding fractions. TABLE 2 hereinabove reports thermal stability (i.e., peak temperature) and percent distribution (i.e., percent enthalpy) of distinct collagen populations, as well as the overall thermal denaturation enthalpies. This collagen population stabilized by high concentration of cros slinking also showed a clear tendency to withstand deterioration induced by heating in a humid atmosphere, as well as by combined heating at 100° C. and exposure to NO atmosphere (50 ppm).

### TGA-DTG Analysis in N₂ Flow

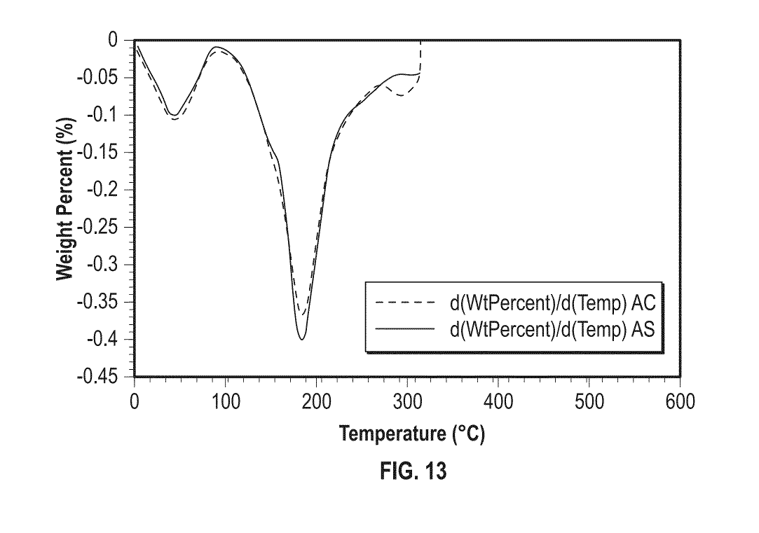

With reference now to the FIGS. 12 and 13 of the DRAWINGS, these figures show the TGA curves obtained by analysis in N₂ flow for the aforementioned “AC” and the “AS” samples. As shown, the “AC” sample exhibits a phase melting at a temperature range between 198° C. to 228° C., while the phase melting occurs for the “AS” at a temperature range of 180° C. to 217° C. The initial slope in the TGA curve for the “AC” sample is more than those corresponding with the “AS” samples, which means the “AC” sample has lost more water content in the progressive temperature compared to the “AS” sample. The first and second peak in the DTG curve for the “AC” sample is broader than those of the “AS” sample, which means that the “AC” sample exhibits more weight changes. Also, for the “AC” sample, the temperature at which maximum weight loss occurs is lower than that of the “AS” sample. After accelerated aging, the temperature range of the melting phase has shifted to higher temperatures because of the structural heterogeneity. The DTG curves for the “control” and the “AC” samples show a number of smaller peaks in addition to the first and second peaks, demonstrating more structural heterogeneity in these samples. Although the general trend of water release was substantially analogous in either cases, the “control” sample had a lower water content compared to the “optimum” sample and the aged samples (“AC” and “AS”), and the “AC” sample had lower water contents compared to the “AS” sample.

It is considered that with the exception of water evaporation, shown by the first TG-process, the other thermal events related to the damage degree are due to age (history) or conservation conditions of the material.

While the present invention has been illustrated by the description of the embodiments thereof, and while the embodiments have been described in detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the breadth or scope of the applicant's concept. Furthermore, although the present invention has been described in connection with a number of exemplary embodiments and implementations, the present invention is not so limited but rather covers various modifications and equivalent arrangements, which fall within the purview of the appended claims.

What is claimed is:

1. A nanocomposite polymeric compound comprising:
a polymeric matrix; and
a plurality of hydroxyapatite (HA) nanoparticles,
wherein said nanoparticles are homogenously suspended in said polymeric matrix.

2. The nanocomposite polymeric compound according to claim 1, wherein said polymeric matrix comprises polyethylene glycol (PEG).

3. The nanocomposite polymeric compound according to claim 2, wherein said polyethylene glycol (PEG) has a molecular weight in the range of about 200 to about 800 daltons.

4. The nanocomposite polymeric compound according to claim 3, wherein said polyethylene glycol (PEG) has a molecular weight of about 400 (PEG400).

5. The nanocomposite polymeric compound according to claim 1, wherein said hydroxyapatite (HA) nanoparticles have an average size of about 50 nm to about 120 nm.

6. The nanocomposite polymeric compound according to claim 5, wherein said hydroxyapatite (HA) nanoparticles have an average size of about 50 nm.

7. A method for producing a nanocomposite polymeric compound comprising the steps of:
preparing a solution of polyethylene glycol (PEG) in deionized water;
adding a plurality of hydroxyapatite (HA) nanoparticles to said solution; and
stirring the resultant solution until semi-transparent and homogenous.

8. The method according to claim 7, wherein the concentration of said PEG in the resultant solution is in a range between about 15% to about 60% by weight.

9. The method according to claim 7, wherein the concentration of said HA nanoparticles in the resultant solution is about 10% by weight.

10. The method according to claim 7, wherein the concentration of said HA nanoparticles in the resultant solution is about 0.1% by volume.

11. A method for the treatment of an object comprising the steps of:
immersing said object in a nanocomposite solution prepared according to the method of claim 7;
removing and drying said object; and
storing the object in a sealed condition for at least one day.

12. The method for the treatment of an object according to claim 11, wherein said step of immersing comprises immersing said object in a polymeric matrix of polyethylene glycol (PEG) admixed with a plurality of hydroxyapatite (HA) nanoparticles.

13. The method for the treatment of an object according to claim 11, wherein said object is a leather object.

14. The method for the treatment of an object according to claim 13, wherein said leather object is an ancient leather object.

15. The method for the treatment of an object according to claim 13, wherein said leather object is selected from the group consisting of goat leather, sheep leather and vegetable tanning leather.

16. The method for the treatment of an object according to claim 13, further comprising the steps of:
exposing said leather object, in a first cycle, to a first ambient temperature and first humidity, said first humidity being about 80%; and subsequently
exposing said leather object, in a second cycle, to a second temperature lower than said first temperature and second humidity lower than said first humidity, and
radiating said leather object with UV radiation.

17. The method according to claim 16, wherein the steps are sequentially repeated for at least 1,000 hours.

18. The method according to claim 16, wherein the first and second cycles take about 16 hours and 8 hours, respectively.

19. The method according to claim 16, wherein said said first ambient temperature is about 40° C. and said second temperature is about 15° C.

20. The method according to claim 16, wherein said second humidity is about 5%.

21. The method according to claim 16, wherein said UV radiation is provided by a UVb lamp having a radiation power of about 8 W.

22. The method for the treatment of an object according to claim 11, wherein said object is parchment.
